(19) United States
(12) Patent Application Publication
(10) Pub. No.: US 2024/0013529 A1
(43) Pub. Date: Jan. 11, 2024

(54) APPARATUS AND METHOD FOR CULLING IMAGES

(71) Applicant: CANON U.S.A., INC., Melville, NY (US)

(72) Inventor: Hironori AOKAGE, Nagoya, Aichi-Ken (JP)

(21) Appl. No.: 18/035,616

(22) PCT Filed: Nov. 8, 2021
(86) PCT No.: PCT/US2021/058435

§ 371 Date: May 5, 2023

Related U.S. Application Data
(60) Provisional application No. 63/111,235, filed on Nov. 9, 2020.

(51) Int. Cl. G06V 10/98; G06V 10/74; G06F 3/04845; G06F 3/0482; G06V 20/30

(52) U.S. Cl. CPC G06V 10/993; G06V 10/761; G06F 3/04845; G06F 3/0482; G06V 10/987; G06V 20/30

(57) ABSTRACT

An apparatus is provided that configures one or more processors to obtain a plurality of photos, group the plurality of photos into groups and identify one or more photos as candidates to remove from among the plurality of photos wherein at least one group has two or more photos that are not the candidates to remove. A control operation is performed to display on a display a screen representing, for each group, one or more photos that are candidates to remove and one or more photos that are not the candidates to remove in distinguishable from each other. In certain embodiments, the grouping is performed based on a similarity and capture time of each photo being analyzed and, in some instances, two or more photos are grouped into a same group when the photos are captured in a consecutive capture mode.

### CROSS-REFERENCE TO RELATED APPLICATIONS

This application claims the benefit of priority from U.S. Provisional patent application Ser. No. 63/111,235 filed on Nov. 9, 2020, the entirety of which is incorporated herein by reference.

### BACKGROUND

### Field

The present disclosure relates to an improved manner for culling images on a computing device.

### Description of Related Art

It is known for computing devices with image capture devices either connected thereto or integrated therewith to capture multiple images during an image capture session. However, as image capture quality increases, so does the size associated with each image captures. Further, when multiple images that appear the same, a problem exists in that that a user may delete or otherwise discard images that are of high quality and that the user might actually want to keep. A system and method according to the present disclosure remedies the drawbacks discussed above by preventing the deletion of high quality images by mistake.

### SUMMARY

According to an embodiment, an apparatus is provided that includes one or more processors; and one or more memories storing instructions that, when executed, configures the one or more processors, to obtain a plurality of photos; group the plurality of photos into groups; identify one or more photos as candidates to remove from among the plurality of photos wherein at least one group has two or more photos that are not the candidates to remove; perform control to display on a display unit a screen representing, for each group, one or more photos that are candidates to remove and one or more photos that are not the candidates to remove in distinguishable from each other.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 is a diagram of an image processing system according to the present disclosure.

FIG. 2 is a flow diagram of an image processing algorithm according to the present disclosure.

FIG. 3 is a user interface caused to be displayed on a processing device by the image processing algorithm of the present disclosure.

FIG. 4 is a user interface caused to be displayed on a processing device by the image processing algorithm of the present disclosure.

FIG. 5 is a user interface caused to be displayed on a processing device by the image processing algorithm of the present disclosure.

FIG. 6 is a user interface caused to be displayed on a processing device by the image processing algorithm of the present disclosure.

FIG. 7 is a user interface caused to be displayed on a processing device by the image processing algorithm of the present disclosure.

FIG. 8 is a user interface caused to be displayed on a processing device by the image processing algorithm of the present disclosure.

FIG. 9 is a user interface caused to be displayed on a processing device by the image processing algorithm of the present disclosure.

FIG. 10 is a user interface caused to be displayed on a processing device by the image processing algorithm of the present disclosure.

FIG. 11 is a user interface caused to be displayed on a processing device by the image processing algorithm of the present disclosure.

FIG. 12 is a user interface caused to be displayed on a processing device by the image processing algorithm of the present disclosure.

FIG. 13 is a user interface caused to be displayed on a processing device by the image processing algorithm of the present disclosure.

FIG. 14 is a block diagram detailing the hardware components of the processing device.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

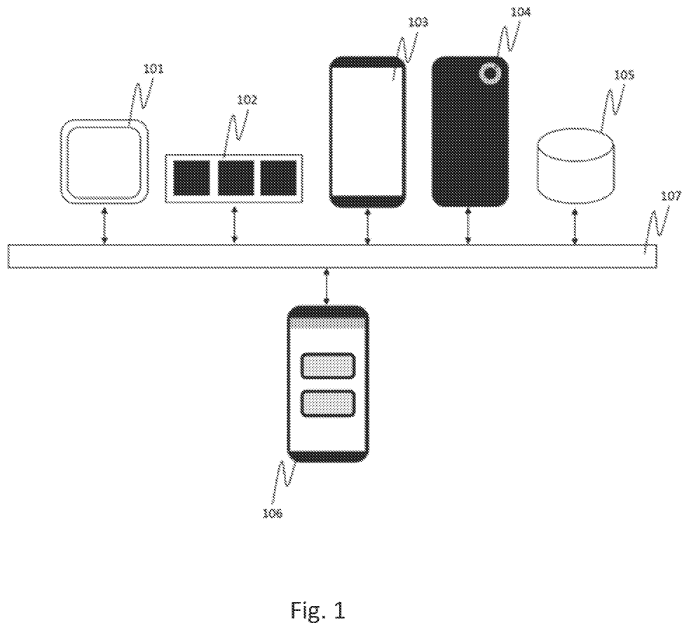

A system according to the present disclosure is illustrated in FIG. 1. An exemplary apparatus for executing the instructions for performing photo culling is a mobile communication device including but not limited to a smart phone, tablet or other portable computing device. The following depicts various aspects of the photo culling apparatus by visually representing the function performed thereby.

In one embodiment, the components described below are embodied in a single device such as a smartphone. In other embodiments, one or more component aspects described in FIG. 1 may be embodied in disparate apparatuses such as an embodiment whereby a terminal is in communication with a remote server. In FIG. 1, 101 represents one or more processor(s) to execute all of algorithmic processing described herein. A memory 102 is provided store all of the instructions to be executed by the one or more processors 101. A display 103 is provided for displaying one more user interfaces 106 which both display one or more photos thereon as well as provide user selectable image elements to enable a user to provide input instructions that can be translated, based on the stored instructions, in to operations for controlling operation of the photo culling processing described herein. The system (apparatus) also includes a camera 104 for capturing one or more images which are then stored in the storage device 105. It should be understood that the photos in the storage device may not only be based on direct image capture by the camera 104 but also may be stored based on download or other acquisition processing from a further application executing on the device including but not limited to a messaging application, an electronic mail application, a cloud storage repository or any other application executing that can access the camera 104 and capture in image. All of the above components are connected by a system bus 107. The system bus 113 may include one or more types of bus structures including a memory bus or memory controller, a peripheral bus, and a local bus using any of a variety of bus architectures.

In operation, the at least one central processing unit (CPU) 101 and memory 102 and can execute instructions stored in the memory 102 to perform one or more of the described operations and/or functions. The one or more processors 101 are in communication with one or more memories 102 (e.g., RAM and/or ROM) and, in some instances executes stored instructions to perform the one or more control operations. In other instances, the one or more processors 101 temporarily store data in the one or more memories 102 that are used in calculation and generation of the various signals and operations described hereinafter. As such, system of FIG. is controlled by using a computer program (one or more series of stored instructions executable by the CPU) and data stored in the RAM and/or ROM. Here, the one or more processors 101 may include (or may be in communication with) one or more dedicated hardware or a graphics processing unit (GPU), which is different from the CPU, and the GPU or the dedicated hardware may perform a part of the processes by the CPU. As an example of the dedicated hardware, there are an application specific integrated circuit (ASIC), a field-programmable gate array (FPGA), and a digital signal processor (DSP), and the like. In some embodiments, the one or more processors 101 may be a dedicated controller. In others, the control system 100 may include a plurality of processors that are in communication with one another and other components of the system to implement the operations described herein.

The following algorithm details a process for culling photos on a mobile communication device. The photo culling application advantageously provides advanced memory management functionality that can reduce the amount of storage on the mobile communication device that is taken up by images that are of unsatisfactory quality. In so doing, the photo culling application performs image analysis to identify characteristics of images known to be associated with a high quality image and presents one or more similar images having less than a desired quality for deletion thereby freeing up memory on the apparatus that is the usable by other applications. The need for sufficient memory management is particular important when updating a mobile device operating system. The number of images able to captured in a single capture session is increasing but not all of the captured images are needed. If the remain, the device storage fills and may prevent other applications from performing their desired functions such as an updating function. Further, when there are plurality of images captured at a given time, the ability to view and display all of the captured images in order to determine which one is the best quality is negatively impacted because there are likely more captured images of the given moment than can be displayed together and evaluated together. As such, the photo culling application advantageously identifies the images that are objectively the highest quality and presents the remaining images for deletion. Thus, the photo culling application improves both the memory management of the device along with providing an improved user interface for viewing photos on an apparatus that traditionally does not have a large display.

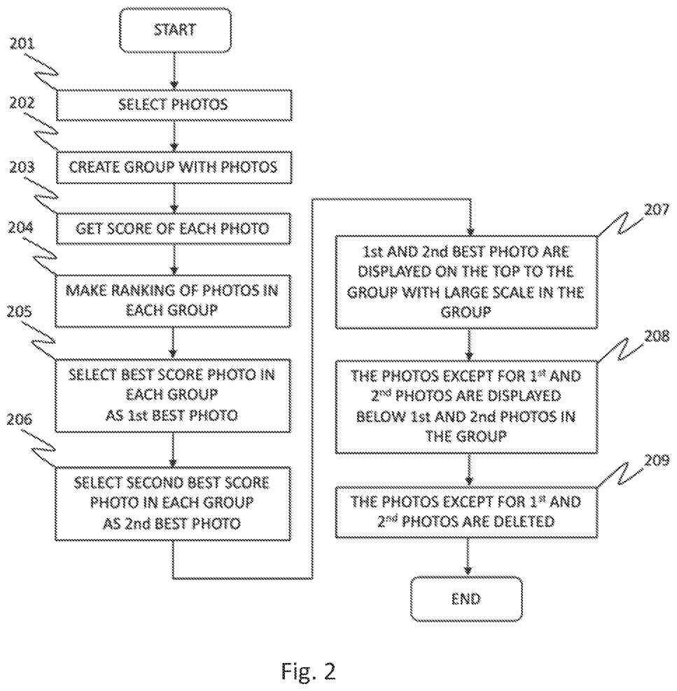

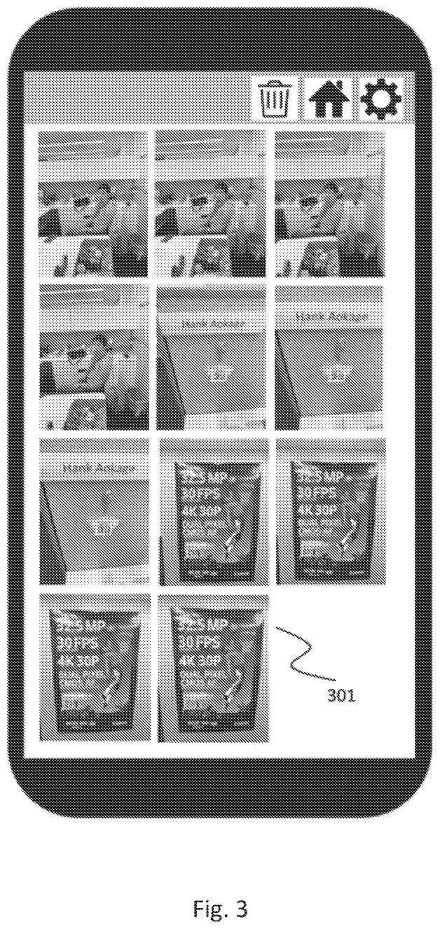

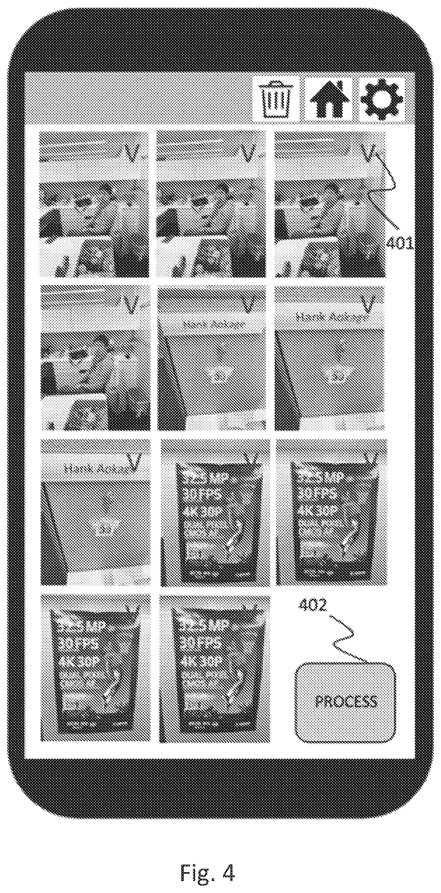

FIG. 2 shows a flow chart which details the processing steps of the photo culling application according to the present disclosure. In Step 201, photos are retrieved from the storage device 105 and presented on the user interface user interface 106 for selection. The presentation for selection identifies which of the plurality of photos stored in the storage device are to be culled. FIG. 3 illustrates the user interface 301 on the display screen on the mobile computing device which shows the photo being displayed prior to selection. The user interface 301 displays the photos as selectable image elements that are able to receive touch input from a user in order to select the photos for culling processing as described below. Once photos are selected via user input, a selection indicator added as an overlay on the photos which is shown 401 in FIG. 4. As shown herein, the selection indicator is a mark over a portion of the image. However, this is described for purposes of example only and the indicator may be any graphical representation of the image that visual indicates that the image was selected for further processing. Once process button 402 is tapped, the processing is started which includes from Step 202 to Step 208 as will now be described.

In Step 202, groups are created with similar photos based on one or more characteristics of the selected images. In one exemplary operation the selected photos are provided as input to a trained machine learning model trained to identify image similarities such as a convolutional neural network. The trained machine learning model determines similarity based one or more image characteristics and time characteristic to generate output groups containing the most similar of the selected images. Figure show the screen that grouping is done. In this exemplary embodiment, the grouping processing has generated a first group 501, a second group 502 and a third group 503. In this embodiment, two or more photos whose characteristic information is determined as similar and the capturing times are determined as shorter than a predetermined time duration are grouped in to the same group. In addition, two or more photos captured in a consecutive capturing mode are grouped into the same group in Step 202.

In Step 203, characteristic scores are calculated for each photo within each of the groups. While it should be understood that this processing occurs on multiple groups, it should also be understood that, based on the selections made in step 201, only a single group may be generated and the characteristic scores for each image in the single group can be calculated. Characteristic calculations preformed in step 203 include the calculation of scores for one or more photo characteristics including (a) sharpness, (b) noise, (c) closed-eye identification and (d) emotion. A final image score is calculated based on these four scores which provides an objective indication representing a quality of the particular photo in the group. It should be noted that while four characteristic (e.g. parameters) are described, the algorithm can use any number of different image characteristics to generate the final image score. For example, the final score may be calculated by three parameters selected from the four parameters, sharpness, noise, closed-eye, and emotion of a photo. Also, the score may be calculated based on other parameters such as brightness, contrast, and/or image focus.

In Step 204, the photos in each group are sorted in descending order of final image score for display in the user interface of the mobile computing apparatus. In Step 205, the best score photo is selected as 1^{st} best photo in a group. Also, in Step 206, second best score photo is selected as 2^{nd} best photo if the score of the photo is above the threshold level in each group. In other words, the best score photo is identified as a photo to remain in the storage 105 regardless of its final score, and the 2^{nd} best photo is identified as a photo to remain if its score is higher than the threshold level.

In Step 207, 1^{st} and 2^{nd} best photos are displayed on top of the group with larger scale than other photos in the group. Also, In Step 208, the photos except for 1^{st} and 2^{nd} best photos are displayed under 1^{st} and 2^{nd} best photos with smaller scale than 1^{st} and 2^{nd} best photo. In one embodiment, the best photo scores represents the highest total score of the particular characteristics analyzed by the processing. However, depending on the characteristics being analyzed, there may be an instance where the best photo is the one that has the lowest total scores. This may be the case if the characteristics being analyzed represent negative photo characteristics such as brightness and noise where the analysis may yield a low score for noise and a low score of darkness meaning that the analyzed image is of higher quality because it is brighter and has less noise.

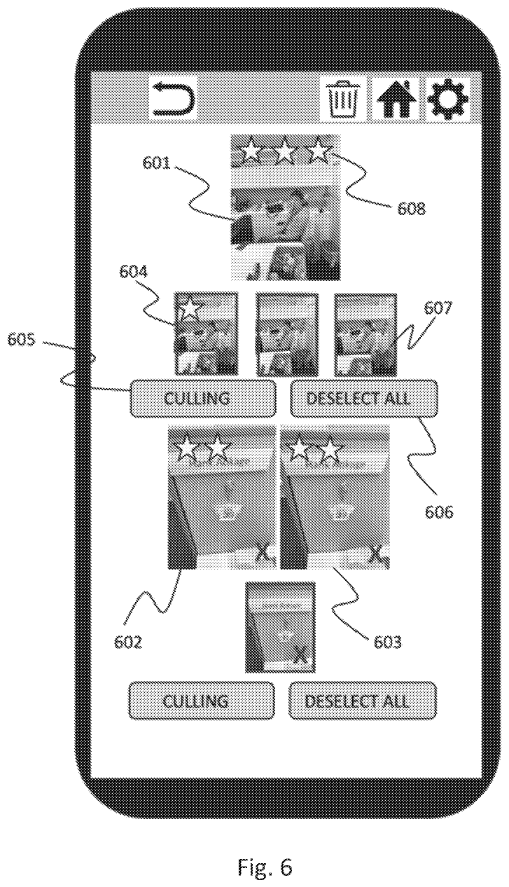

FIG. 6 illustrates the display processing of steps 204-207 showing the manner of displaying the photos after Step 206. Image 601 shows represents the 1^{st} best photo in the first group 501. Image 602 shows the 1^{st} best photo as well as image 603 which represents the 2^{nd} best photo in second group 502. Images 604 illustrates the photos which are candidates to be deleted from storage. The edge of the photos are colored (e.g. in red or any other indication color) to show these photos are candidates to be deleted. Image element 605 represents a button that can receive user input which causes photos 604 which are candidates to be deleted, to be deleted. Image element 606 represents a button that can receive user input to deselect all of the photos in a group. Additionally, image element 607 represents an indicator identifying candidate photos which are same as red border on the photo which have been identified for deletion. FIG. 6 also provides one or more score indicators 608 that visually represent final score of photos in an easy to understand, non-numerical fashion. As shown herein different score indicators may be labeled on different photos to show which have the higher final score as compared to others. In one embodiment, the score indicator 608 can also indicate the threshold whereby photos that are not determined to be the best shot still can be deemed acceptable and not marked for deletion.

In Step 209, the photos except for 1^{st} and 2^{nd} photos are deleted in response to providing touch input by tapping (or holding) the culling button 605 shown in FIG. 6. Also, a user can select photos manually to identify the photos either shown more prominently should be deleted or those shown less prominently should remain in storage by providing a touch input on the individual photo. When culling button 605 is tapped, the delete candidate photos 604 are deleted and marked as “culled”, and photo 601 is left and marked as “processed”. Then photo 601 is not displayed to show the processing of this group is finished. In other words, the photo 601 is hidden after tapping the culling button 605 for letting a user know the process for this group is done.

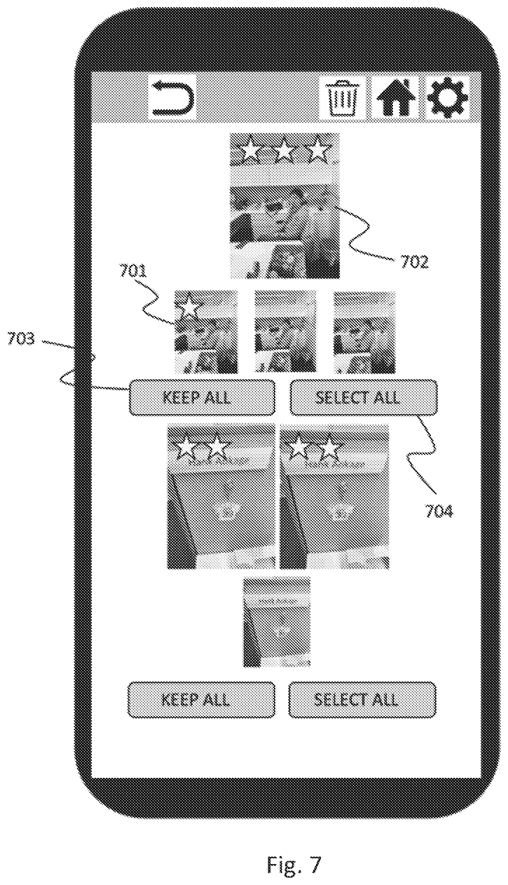

FIG. 7 illustrates a display screen after processing resulting from the selection of image element 606 is provided. In this screen the button 605 is transformed to “KEEP ALL” button 703, and button 606 is transformed to “SELECT ALL” button 704. Also, the selection indicators and signs 607 in FIG. 6, which show the candidates of delete, are removed. So both 701 photos and 702 photo are left and marked as “processed”. Then both 701 and 702 are not displayed to show the processing of the group is finished. As another example, in response to tapping the button 606, at least one of the selection indicators such as the red borders and signs 607 may be changed, instead of removed, into another sign (or indicator of another color) indicating that the image is not a candidate for deletion. As another example, in response to tapping the button 606, photos belonging to a corresponding group may be hidden in display for showing that these photos are no longer the process target.

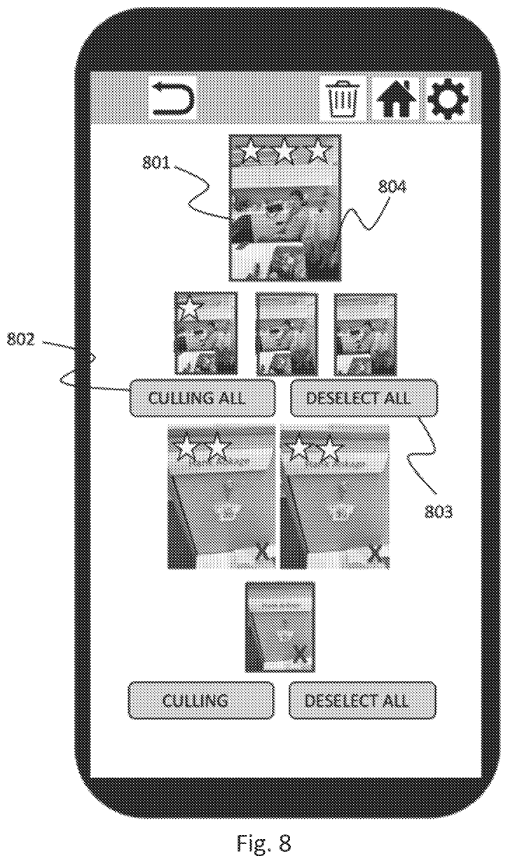

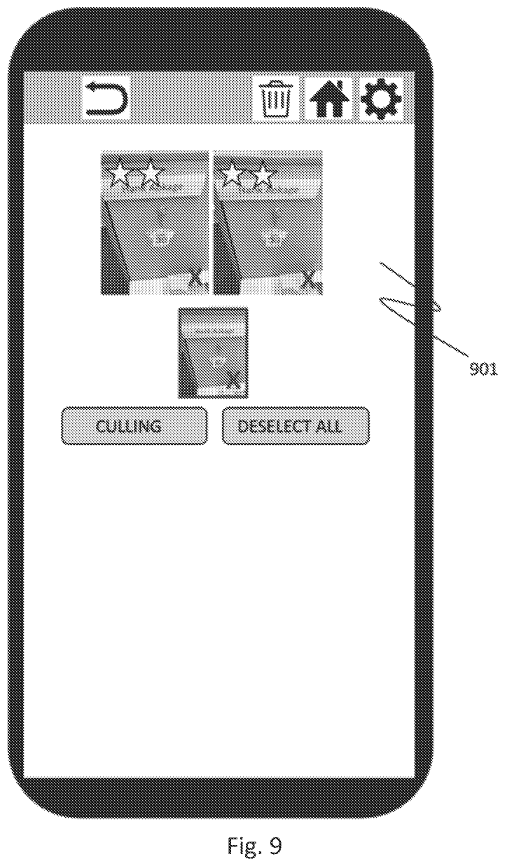

FIG. 8 illustrates a display screen situation when touch input of image element 704 in FIG. 7 is provided. All of the photos including 801 in the group are selected as candidates to be culled, with the red border and the sign 804. Also, image element button 703 is transformed to “CULLING ALL” as well as image element button 704 being transformed to “DESECT ALL”. When user input representing a selection of image element button 802 is received, all of the photos in the group which have selection indicators 804 (e.g. red border and signs). After the processing is completed for one group, the group is not displayed and next group is shown instead of previous group. FIG. 9 shows this situation and 901 shows the new group to be processed.

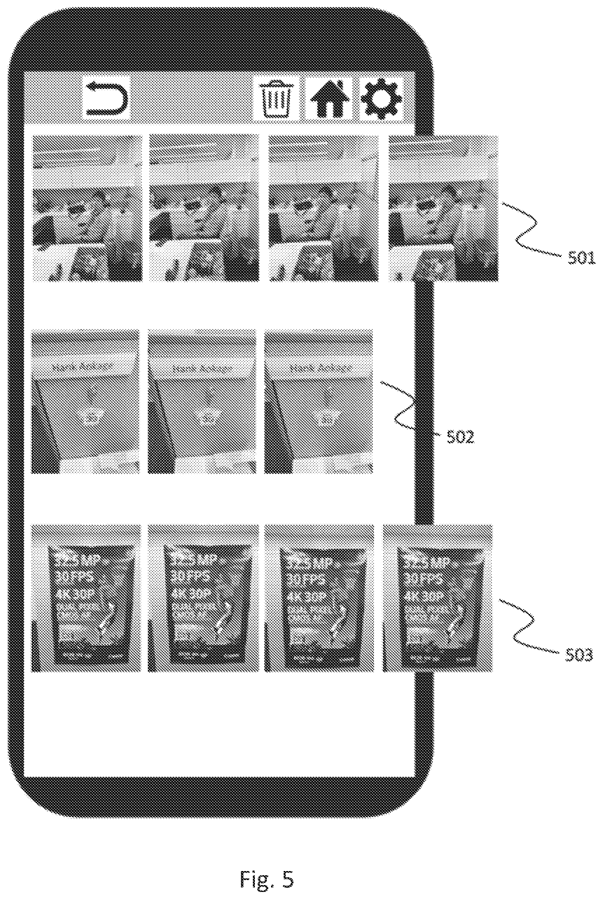

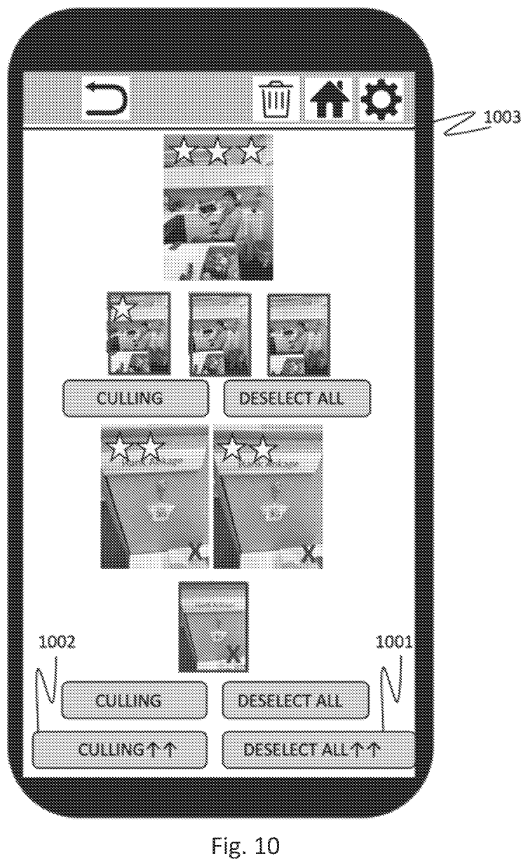

In another embodiment, the culling processing described above pertaining to a single group of images may be similarly applied to a plurality of groups of images such as those in the first and second groups 501 and 502 in FIG. 5. FIG. 10 illustrates a display screen displaying a user interface for deleting or deselecting multiple groups of images. In this example, from border 1003 to the button 1002 and 1001 represent images that are candidates for deletion or deselection. When culling button 1002 is tapped, all of the photos from border 1003 to the button 1002 or 1001, which are selected as delete candidates, are deleted. On the other hand, when deselected button 1001 is tapped, all of the photos from border 1003 to the button 1002 or 1001 are deselected. Note that the border 1003 can be moved based on user operations by selecting and moving the border to define the groups to be processed. This movement can scroll along the screen in an upward or downward motion depending on the number of images originally selected for processing and the number of groups determined by the grouping processing described above.

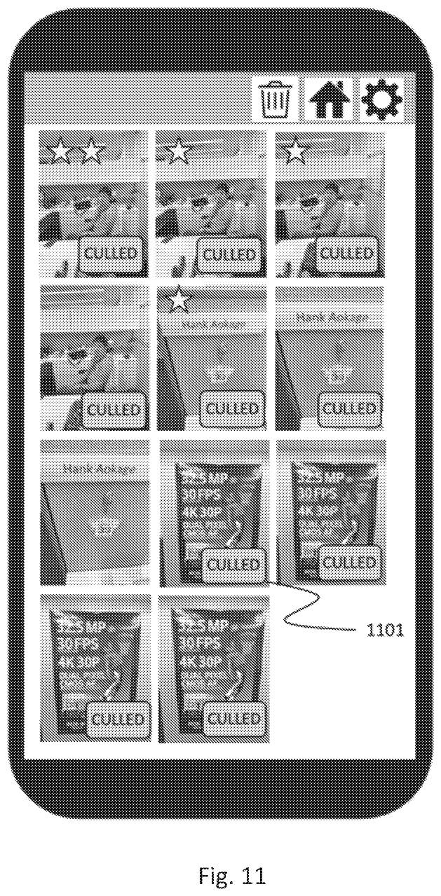

FIG. 11 illustrates a user interface representing trash processing of images when images are deleted by the culling process. The photos are marked as “CULLED” shown as 1101. The user can navigate to this user interface and selectively delete these images permanently. Alternatively, a user may provide a touch input on the indicator “CULLED” which can restore the image to the storage device 105. In a further embodiment, the user interface may provide a selectable image element that causes offload processing to occur whereby the images labeled “CULLED” are communicated to a remote location such as cloud storage of other external storage device so that they can be deleted from device storage 105 but remain for later use by the user on another device.

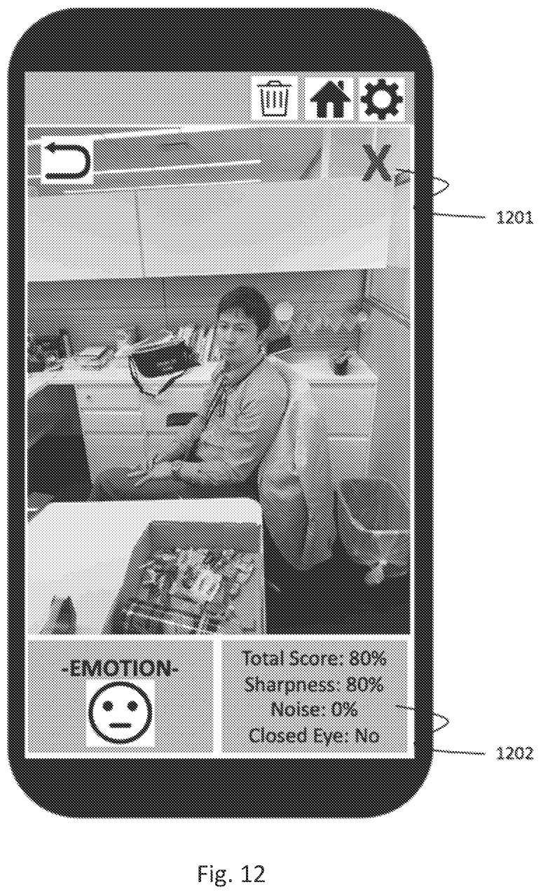

FIG. 12 illustrates a user interface including an enlarged image having additional image information being displayed therewith. In any screen, if the photos are tapped, the enlarged image of FIG. 12 is displayed. User can delete in this screen as well with tapping 1201. Also all of the scores which are calculated in Step 203 are displayed as 1202 and includes an emotion indicator indicating a type of emotion exhibited by the subject of the image. The emotion indicator may be an emoji or may be a descriptive term representing the detected emotion.

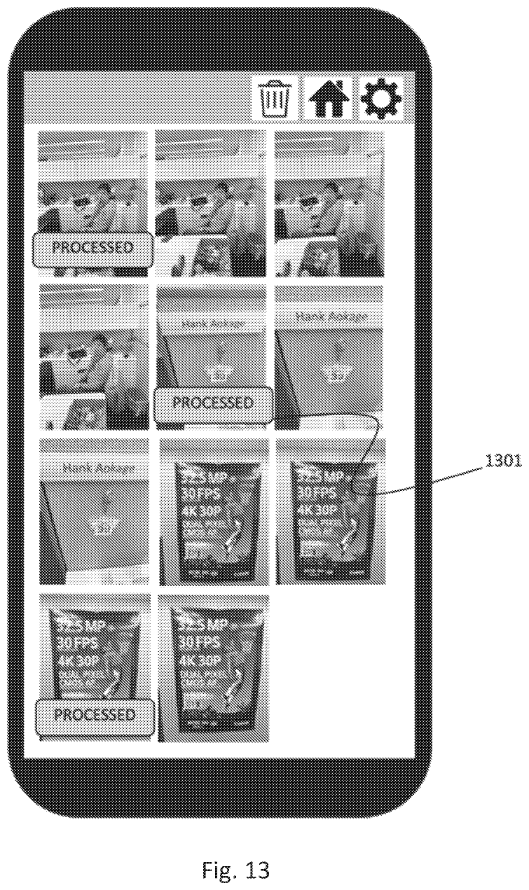

Also, after all of the process above, when photo gallery is opened, the processed photos have sign as “processed” as shown 1301 in FIG. 13. Thus the display is improved to be able to display more images at a same time while showing the best quality images stored in the storage device 105.

The above describes a photo culling algorithm performed by a mobile computing device or control apparatus that includes one or more processors; and one or more memories storing instructions that, when executed, configures the one or more processors to obtain a plurality of photos, group the plurality of photos into groups and identify one or more photos as candidates to remove from among the plurality of photos wherein at least one group has two or more photos that are not the candidates to remove. A control operation is performed to display on a display a screen representing, for each group, one or more photos that are candidates to remove and one or more photos that are not the candidates to remove in distinguishable from each other. In certain embodiments, the grouping is performed based on a similarity and capture time of each photo being analyzed and, in some instances, two or more photos are grouped into a same group when the photos are captured in a consecutive capture mode.

For each of the plurality of photos, a score regarding at least one of sharpness, noise, closed eye and emotion is determined and the photos determined as the candidates to be removed are identified based on the score of each photo in each group. In one embodiment, the plurality of photos are displayed according to a spatial display order based on a belonging to group and the score of each photo. In certain instances, a photo having a highest score in a group is displayed larger than other photos and the identified photos as candidates to remove are displayed smaller than other photos. Further, for each group a photo having a highest score is identified as not a candidate to remove and wherein a photo having a second highest score is identified as not a candidate to remove if the second highest score is higher than a predetermined threshold.

The apparatus causes display of different display screens that include selectable image elements which received input from a user to cause particular processing to occur. In one embodiment, the screen contains a button for indicating to remove the candidates belonging to a group. In another embodiment, the screen contains a button for indicating to remove the candidates belonging to two or more groups. The screen also contains a display component for designating the two or more groups. In further embodiment, the screen contains a switch button for indicating to release a photo from the candidate to remove wherein in response to an operation to the switch button, a sign on the screen representing the candidate to remove is hidden in display. Alternatively, in response to an operation to the switch button, a first sign representing the candidate to remove is changed to a second sign representing not the candidate to remove. Further, in response to an operation to the switch button, a photo corresponding to the switch button is hidden in display.

A trash box screen is caused to be displayed whereby the trash box screen represents (i) photos removed by a culling instruction for removing the photos identified as the candidates to remove and (ii) photos removed by another remove instruction, in distinguishable from each other.

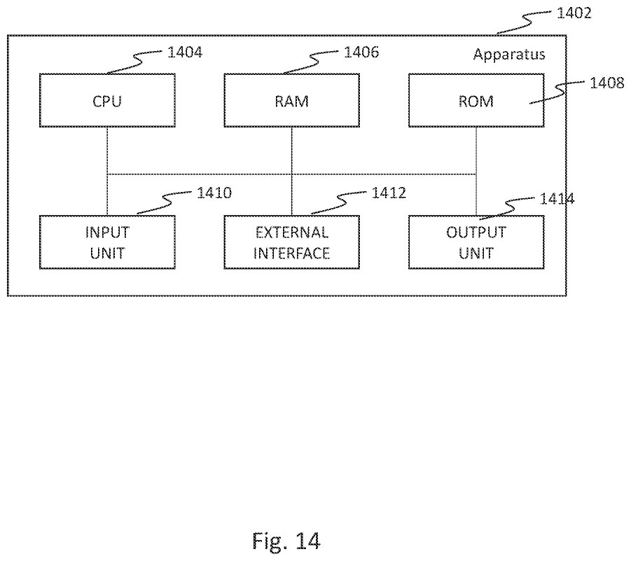

FIG. 14 illustrates the hardware of an apparatus that can be used in implementing the above described disclosure. The apparatus 1402 includes a CPU 1404, a RAM 1406, a ROM 1408, an input unit 1410, an external interface 1412, and an output unit 1414. The CPU 1404 controls the apparatus 1402 by using a computer program (one or more series of stored instructions executable by the CPU) and data stored in the RAM 1406 or ROM 1408. Here, the apparatus may include one or more dedicated hardware or a graphics processing unit (GPU), which is different from the CPU 1404, and the GPU or the dedicated hardware may perform a part of the processes by the CPU 1404. As an example of the dedicated hardware, there are an application specific integrated circuit (ASIC), a field-programmable gate array (FPGA), and a digital signal processor (DSP), and the like. The RAM 1406 temporarily stores the computer program or data read from the ROM 1408, data supplied from outside via the external interface 1412, and the like. The ROM 1408 stores the computer program and data which do not need to be modified and which can control the base operation of the apparatus. The input unit 1410 is composed of, for example, a joystick, a jog dial, a touch panel, a keyboard, a mouse, or the like, and receives user's operation, and inputs various instructions to the CPU 1404. The external interface 1412 communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit 1414 is composed of, for example, a display unit such as a display and a sound output unit such as a speaker, and displays a graphical user interface (GUI) and outputs a guiding sound so that the user can operate the apparatus as needed.

The scope of the present invention includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A control apparatus comprising:
one or more processors; and
one or more memories storing instructions that, when executed, configures the one or more processors, to:
obtain a plurality of photos;
group the plurality of photos into groups;
identify one or more photos as candidates to remove from among the plurality of photos wherein at least one group has two or more photos that are not the candidates to remove;
perform control to display on a display unit a screen representing, for each group, one or more photos that are candidates to remove and one or more photos that are not the candidates to remove in distinguishable from each other.

2. The control apparatus according to claim 1, wherein the one or more processors are further configured to
determine, for each of the plurality of photos, a score regarding at least one of sharpness, noise, closed eye and emotion, and
wherein the photos as the candidates to remove are identified based on the score of each photo in each group.

3. The control apparatus according to claim 2, wherein the plurality of photos are displayed according to a spatial display order based on a belonging group and the score of each photo.

4. The control apparatus according to claim 1, wherein the grouping is performed based on a similarity and a capturing time of each photo.

5. The control apparatus according to claim 4, wherein two or more photos are grouped into a same group when the photos are captured in a consecutive capturing mode.

6. The control apparatus according to claim 2, wherein a photo having a highest score in a group is displayed larger than other photos.

7. The control apparatus according to claim 2, wherein the identified photos as candidates to remove are displayed smaller than other photos.

8. The control apparatus according to claim 2, wherein for each group a photo having a highest score is identified as not a candidate to remove and wherein a photo having a second highest score is identified as not a candidate to remove if the second highest score is higher than a predetermined threshold.

9. The control apparatus according to claim 1, wherein the screen contains a button for indicating to remove the candidates belonging to a group.

10. The control apparatus according to claim 1, wherein the screen contains a button for indicating to remove the candidates belonging to two or more groups.

11. The control apparatus according to claim 10, wherein the screen contains a display component for designating the two or more groups.

12. The control apparatus according to claim 1, wherein the screen contains a switch button for indicating to release a photo from the candidate to remove.

13. The control apparatus according to claim 12, wherein in response to an operation to the switch button, a sign on the screen representing the candidate to remove is hidden in display.

14. The control apparatus according to claim 12, wherein in response to an operation to the switch button, a first sign representing the candidate to remove is changed to a second sign representing not the candidate to remove.

15. The control apparatus according to claim 12, wherein in response to an operation to the switch button, a photo corresponding to the switch button is hidden in display.

16. The control apparatus according to claim 1, wherein a trash box screen is displayed, the trash box screen representing (i) photos removed by a culling instruction for removing the photos identified as the candidates to remove and (ii) photos removed by another remove instruction, in distinguishable from each other.

17. A control method executed by one or more processors comprising:
obtaining a plurality of photos;
grouping the plurality of photos into groups;
identifying one or more photos as candidates to remove from among the plurality of photos wherein at least one group has two or more photos that are not the candidates to remove; and
performing control to display on a display unit a screen representing, for each group, one or more photos that are candidates to remove and one or more photos that are not the candidates to remove in distinguishable from each other.
